(19) United States
(12) Patent Application Publication
(10) Pub. No.: US 2026/0154892 A1
(43) Pub. Date: Jun. 4, 2026

(54) SYSTEM AND METHOD FOR CLOUD PROJECTION

(71) Applicant: Universal City Studios LLC, Universal City, CA (US)

(72) Inventors: Jason Weeks, Orlando, FL (US); Rachel Elise Rodgers, Orlando, FL (US); Elise Ann Sockman, Orlando, FL (US); Carson Luter, Orlando, FL (US)

(21) Appl. No.: 19/406,610

(22) Filed: Dec. 2, 2025

Related U.S. Application Data
(60) Provisional application No. 63/727,384, filed on Dec. 3, 2024.

(51) Int. Cl. G06T 13/60; G06T 19/00

(52) U.S. Cl. CPC G06T 13/60; G06T 19/00

(57) ABSTRACT

A method of cloud projection includes emitting a cloud, detecting a location of the cloud, mapping the location of the cloud into three-dimensional space, and projecting a visual effect onto the cloud.

### CROSS-REFERENCE TO RELATED APPLICATION

This application claims priority from and the benefit of U.S. Provisional Ser. No. 63/727,384 , entitled “SYSTEM AND METHOD FOR CLOUD PROJECTION”, filed Dec. 3, 2024, which is hereby incorporated by reference in its entirety for all purposes.

### BACKGROUND

The present disclosure relates generally to creating visual effects in curated environments.

New and unexpected visual effects can encourage guest engagement and satisfaction in curated environments, such as amusement parks, museums, historical sites, zoos, parks, art galleries, fairs, trade shows, conferences, conventions, expos, festivals, and so forth. Accordingly, new techniques for providing visual effects in curated environments are needed in order to increase guest engagement.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below

In an embodiment, a cloud projection system includes a fogger, a sensor, a server, and a projector. The fogger is configured to emit a cloud. The sensor is configured to detect a location of the cloud and output data indicative of the location of the cloud. The server includes processing circuitry and a memory, accessible by the processing circuitry. The memory stores instructions that, when executed by the processing circuitry, cause the processing circuitry to receive the data indicative of the location of the cloud from the sensor, map the data indicative of the location of the cloud into three-dimensional space, generate a visual effect to be projected onto the cloud based on the mapping, and output instructions to project the generated visual effect onto the cloud. The projector is configured to receive the instructions from the server and project the generated visual effect onto the cloud based on the instructions.

In an embodiment, a method of cloud projection includes emitting a cloud, detecting a location of the cloud, mapping the location of the cloud into three-dimensional space, and projecting a visual effect onto the cloud.

In an embodiment, a non-transitory computer readable medium stores instructions that, when executed by processing circuitry, cause the processing circuitry to receive data indicative of a location of a cloud from a sensor, map the data indicative of the location of the cloud into three-dimensional space, generate a visual effect to be projected onto the cloud based on the mapping, and output instructions to project the generated visual effect onto the cloud of vapor to a projector.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic of a cloud projection system being used in an amusement park, in accordance with an embodiment of the present disclosure;

FIG. 2 is a schematic of the cloud projection system of FIG. 1, in accordance with an embodiment of the present disclosure;

FIG. 3 is a block diagram of example components of a computing device that could be used in the cloud projection system of FIGS. 1 and 2, or some other device of FIGS. 1 and 2, in accordance with an embodiment of the present disclosure; and

FIG. 4 is a flowchart of a process for cloud projection, in accordance with an embodiment of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments.

The present disclosure is directed to techniques for projecting visual effects onto a cloud (e.g., of vapor, smoke, aerosol, particulate matter, etc.) in a curated environment (e.g., amusement parks, museums, historical sites, zoos, parks, art galleries, fairs, trade shows, conferences, conventions, expos, festivals, and so forth) using a cloud projection system. The cloud projection system includes a fogger, one or more sensors, a processor-based computing device, and a projector. The fogger emits a cloud or cloud material, such as vapor, smoke, aerosol, dust, particulate matter, and so forth to form a cloud in the curated environment. The cloud may be emitted on a schedule (e.g., at a particular time, of after a period of time has elapsed), in response to an input (e.g., a button being pressed), in response to some condition being detected (e.g., light conditions, sound conditions, a person, animal, or object being present, a command being received, etc.), and so forth. One or more sensors (e.g., LiDAR sensors) detect the location of the cloud and output data representative of the location of the cloud to the computing device. The location could be determined by a center of mass and a radius, a cluster of coordinates that fall within the cloud, a location of a boundary at which some measured value (e.g., visibility, reflectivity, density, concentration, etc.) crosses some threshold value, or some combination thereof. The computing device receives the data from the one or more sensors and maps the location of the cloud into three-dimensional space. The computing device retrieves data defining one or more visual effects and generates one or more visual effects to be projected onto the cloud. The computing device generates instructions to project the visual effects onto the cloud and outputs the instructions to one or more projectors, which project the visual effects onto the cloud in accordance with the instructions. The visual effects may include, for example, constant or flashing light of one or more colors, sparkles representing magic and/or a spell, an animal, such as a bug, a bird, a worm, etc., bubbles, miniaturized human and non-human characters, ghosts, fictional characters, and so forth. Further, visual effects projected from multiple projectors may create a three-dimensional holographic-like effect, creating the visual effect for a guest in the curated environment that the effect being projected onto the cloud is actually present in the cloud.

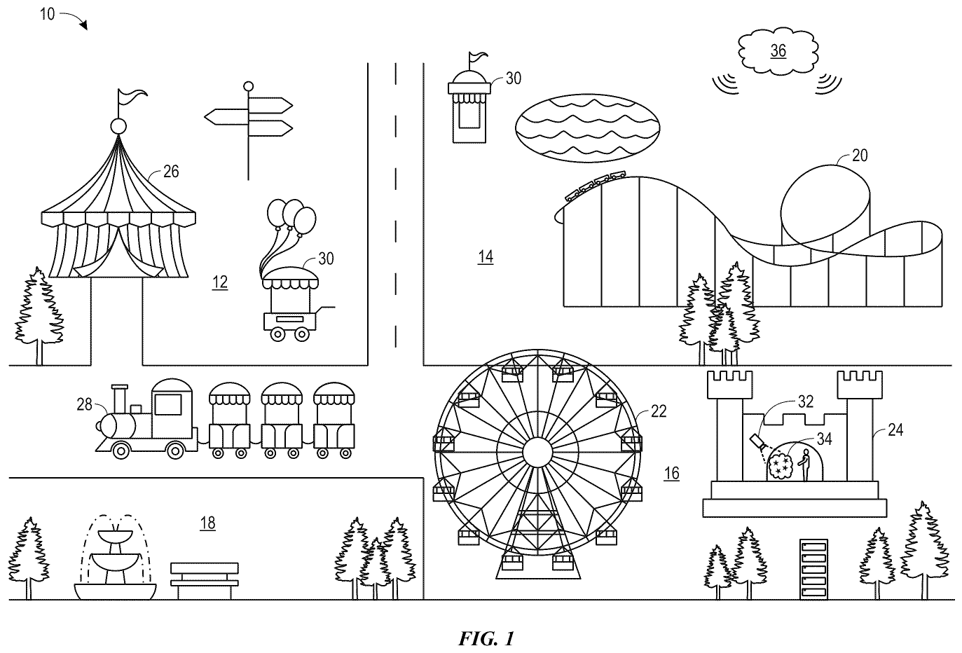

FIG. 1 is a schematic of an amusement park 10. The amusement park 10 may include and/or be separated into one or more sections or lands, such as a first land 12, a second land 14, a third land 16, and a fourth land 18. Each of the lands 12, 14, 16, 18 may include one or more attractions. As shown in FIG. 1, the attractions may include rides, such as roller coasters 20, Ferris wheels 22, or attractions in which a guest is moved through an environment, environments through which guests walk, such as castles 24, performance venues 26, and so forth. The amusement park 10 may also include transportation 28, such as trams, trains, trolleys, and so forth that are configured to move guests within or between lands 12, 14, 16, 18 of the amusement park 10. Further, the amusement park 10 may include one or more vending locations 30. The vending locations 30 may be stationary (e.g., a storefront), mobile (e.g., a cart), or semi-mobile (e.g., a stand), and configured to sell items, such as food, merchandise, toys, souvenirs, toiletries, and so forth to guests.

Some of the attractions at the amusement park 10 may include characters (e.g., actors) that utilize visual effects to improve the guest experience and increase guest engagement. For example, as shown in FIG. 1, the castle 24 may include a cloud projection system 32 configured to detect a cloud 34 and project visual effects (e.g., light and/or images) onto the cloud 34. For example, the cloud 34 may be emitted by a fogger. The fogger may be a fog machine or some other device designed to emit a cloud 34 and/or materials to form a cloud. In some embodiments, the fogger may be a prop or a show element, such as a hand-held object (e.g., a magic wand, a blaster, etc.) held by a character or a guest that emits the cloud 34 or cloud material. Accordingly, the fogger may be controlled by the character or guest holding the fogger (e.g., pushing a button, moving the fogger in a particular way, etc.), or the fogger may be controlled by a control system (e.g., to emit a cloud at certain times, when certain conditions are present, when objects are detected, when a command is received from a remote location, etc.). The cloud projection system 32 includes one or more sensors (e.g., Light Detection and Ranging (LiDAR) sensors) that detect the presence and/or location of the cloud 34. The cloud projection system 32 (e.g., via a server 36) maps the cloud 34 based on data received from the sensors and controls a projector to project visual effects (e.g., light, images, animations, sprites, etc.) onto the cloud 34 to create a holographic-like effect or visual effects appearing in three-dimensional space. As the cloud 34 moves and/or dissipates, the sensors may collect additional data about the presence and/or location of the cloud 34 and the cloud projection system 32 may adjust the projection of visual effects onto or into the cloud 34 based on movement or dissipation of the cloud 34.

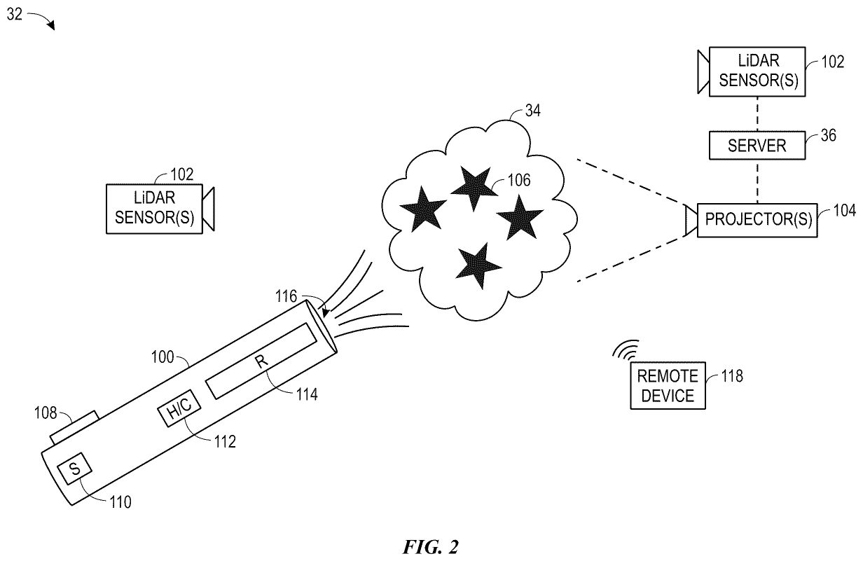

FIG. 2 is a schematic of the cloud projection system 32 of FIG. 1. As shown, the cloud projection system 32 includes a fogger 100 configured to emit a cloud 34 or materials to form a cloud 34, one or more sensors 102 (e.g., LiDAR sensors) configured to detect the presence and/or location of the cloud 34, a server 36, and one or more projectors 104 configured to project visual effects 106 (e.g., light, images, animations, sprites, etc.) onto the cloud 34.

As previously described, the fogger 100 is configured to emit the cloud 34 or material that forms the cloud. The fogger 100 may be stationary, such as a fog machine, or some other device configured to emit clouds 34 from a setting. In some embodiments, the fogger 100 may not be visible to guests and may be configured to emit a cloud 34 into or through a feature of an environment. For example, the fogger 100 may emit a cloud 34 through a crater in an environment, through a porthole or other feature of a vehicle, through a hole in a plant or a tree, and so forth. In some embodiments, the fogger 100 may be a hand-held device, such as a prop (e.g., the fogger 100 may be the prop itself or may be integrated into the prop) held by a guest or a character. For example, the fogger 100 may represent a magic wand, a blaster, a spray bottle (e.g., for perfumes, magic potions, etc.), and so forth.

The fogger 100 may be configured to emit a cloud 34 on a schedule, in response to receiving an input, in response to some condition being met, etc. For example, the fogger 100 may be configured to emit a cloud 34 at a specific time, or at a specific moment within a sequence of events (e.g., at a moment in a skit or sequence performed by one or more characters). In some embodiments, the fogger 100 may include a button 108 (e.g., a trigger) for receiving inputs. A guest or character may press the button 108, which causes the fogger 100 to emit a cloud 34. In some embodiments, the fogger 100 may detect a condition (e.g., via one or more sensors 110, such as motion sensors, audio/sound sensors, proximity sensors, microphones, light detectors, etc.) and emit a cloud 34 in response to detecting the condition. For example, the fogger 100 may detect when it has been moved in a particular way or through a particular motion and emit a cloud 34. Further, the fogger 100 may emit a cloud 34 in response to certain sounds (e.g., voice commands, sound effects, etc.), flashes of light (e.g., light of a particular intensity/brightness, light at a particular wavelength, light flashing at a particular frequency, etc.), and so forth. Additionally, the fogger 100 may emit a cloud 34 in response to connecting to another device or detecting the presence of an object via radio frequency identification (RFID), Bluetooth, WiFi, near field communication (NFC), or some other communication protocol. The fogger 100 may also be configured to emit a cloud 34 in response to receiving a command from another device (e.g., remote device 118), such as the server 36, a controller, a remote trigger, a mobile device, etc.

The cloud 34 emitted by the fogger 100 may be water vapor or vapor of some other fluid, smoke, aerosol, dust, particulate matter, and so forth. In some embodiments, the fluid may be a solution or mixture that includes particles of other materials (e.g. metals, ceramics, etc.) that may make the cloud 34 easier to detect via the sensor 102 and/or make the visual effects 106 projected onto the cloud 34 by the projectors 104 more visible to spectators and/or bystanders. Further, in some embodiments, the fluid may be heated or cooled in order to make the cloud 34 easier to detect via the sensor 102, make the visual effects 106 projected onto the cloud 34 by the projectors 104 more visible to spectators and/or bystanders, and/or to make the cloud 34 have different characteristics (e.g., dissipate slower or faster, stay in place, etc.). Accordingly, the fogger 100 may include heating and/or cooling elements 112 for heating and/or cooling the fluid. Further, the fogger 100 may include one or more reservoirs 114 (e.g., a first reservoir and one or more additional reservoirs) for one or more fluids (e.g., a first fluid and one or more additional fluids) or substances (e.g., a primary fluid and one or more additives), as well as a nozzle 116, diffuser, or other component for turning liquid fluid into vapor for emission.

The one or more sensors 102 may be used to detect the presence and/or location of the cloud 34. As shown, the vapor projection system 32 may include multiple sensors 102 (e.g., a first sensor and one or more additional sensors) in order to, for example, triangulate the location of a cloud 34 or to detect multiple clouds 34. The cloud 34 may be identified based on reflectivity, visibility, density, concentration, etc. being above some threshold value. In some embodiments, a boundary may be identified based upon the point at which some measured value crosses some threshold value. In such embodiments, a point inside the boundary may be assumed to be inside the cloud 34. In some embodiments, visual characteristics (e.g., visibility, reflectivity) may act as a proxy for concentration, density, or some other chemical characteristic. Correspondingly, in some embodiments, measured chemical characteristics, such as concentration or density, may be used as a proxy for visual characteristics of the cloud 34, such as visibility, reflectivity, and so forth. Though the sensors 102 shown in FIG. 2 are LiDAR sensors, it should be understood that some embodiments may include other sensors, such as imaging sensors, infrared sensors, RADAR, light detection sensors, proximity sensors, chemical sensors, or any combination thereof. The sensors 102 may pass data (e.g., first data and one or more sets of additional data) representative of the presence and/or position of the cloud 34 to the server 36 for processing. The location of the cloud 34 may be represented based on a center of mass, a radius from which the cloud 34 extends from the center of mass, a cluster of points that fall inside the cloud 34, a series of points that correspond to an outer boundary of the cloud 34, or some combination thereof.

The server 36 combines and/or stitches together data sets from multiple sensors 102, if multiple sensors 102 are being used, and maps the received data onto a coordinate system to generate coordinates of the cloud 34 in three-dimensional space. As previously described, the coordinates may identify the cloud 34 based on a center of mass and a radius from which the cloud 34 extends from the center of mass, a cluster of points that fall inside the cloud 34, a series of points that correspond to an outer boundary of the cloud 34, or some combination thereof. The server 36 retrieves data from memory defining visual effects (e.g., light, images, animations, sprites, etc.) to be projected onto the cloud 34. For example, the data may be defined by scripts or portions of code stored in memory. The scripts or portions of code may define various characteristics of the visual effects (e.g., light, images, animations, sprites, etc.), such as shape, size, how the visual effect articulates as it moves, the speed of the visual effect, and so forth. In some embodiments, one or more parameters of the visual effects may be adjustable. Accordingly, a mapping routine may determine how and where to project the visual effects in order to project the visual effects onto the cloud 34 in accordance with the script, portion of code, and/or one or more customizable parameters. In some embodiments, mapping may utilize artificial intelligence (AI) and/or machine learning (ML) to map data received from the sensors 102 into three-dimensional space. Further, the mapping may involve generating and/or updating a digital twin of the cloud 34, a digital twin of the visual effects 106, a digital twin that encompasses the cloud 34 and the visual effects 106, separate digital twins for the cloud 34 and the visual effects 106, or some combination thereof. As used herein, a digital twin is a virtual representation of a physical object, system, process, or service that is updated in real-time with data to mimic its structure, state, and behavior. If the cloud 34 has contours and the visual effects 106 are projected over a contour or change in contours, a projection routine (e.g., a projection mapping routine) may be used (e.g., executed) to adjust the visual effects 106 so the visual effects do not appear distorted when projected onto the contours of the cloud 34. The server 36 passes instructions to the one or more projectors 104 to project the visual effects into and/or onto the space occupied by the cloud 34.

The one or more projectors 104 (e.g., a first projector and one or more additional projectors) receive instructions from the server 36 and project visual effects 106 (e.g., a first generated visual effect and one or more additional visual effects) into the space occupied by the cloud 34 in accordance with the instructions. As previously discussed, the cloud projection system 32 may include multiple projectors 104. Accordingly, the server 36 may provide different instructions to different projectors 104 and/or have different projectors 104 project different visual effects 106 onto one or more cloud 34 to create a visual effect 106. In some embodiments, use of multiple projectors 104 to project visual effects 106 onto a single cloud 34 may be used to create a three-dimensional and/or holographic-like visual effect (e.g., a visual effect that has width, height, and depth) on the cloud 34. The visual effects 106 may include, for example, constant or flashing light of one or more colors, sparkles representing magic and/or a spell, an animal, such as a bug, a bird, a worm, etc., bubbles, miniaturized human and non-human characters, ghosts, fictional characters, and so forth.

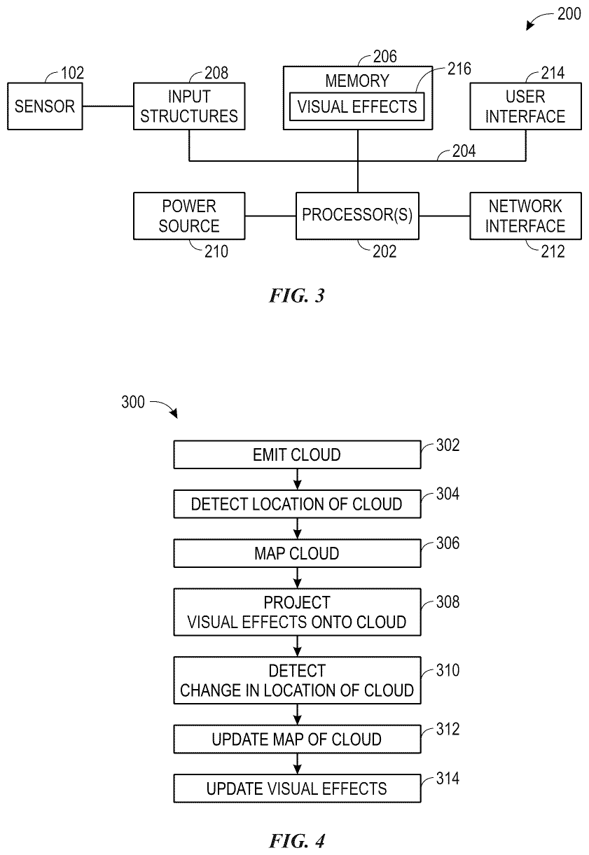

FIG. 3 illustrates a block diagram of example components of a computing device 200 that is configured to be used within the cloud projection system 32, the servers 36, or some other device within the amusement park 10 shown in FIG. 1. As used herein, a computing device 200 may be implemented as one or more computing systems including laptop, notebook, desktop, tablet, or workstation computers, as well as server type devices, network devices, such as routers, switches, edge devices, etc., internet of things (IoT) devices, microprocessors, or portable, communication type devices, such as cellular telephones and/or other suitable computing devices.

As illustrated, the computing device 200 includes various hardware components, such as one or more processors 202, one or more busses 204, memory 206, input structures 208, a power source 210, a network interface 212, a user interface 214, and/or other computer components useful in performing the functions described herein.

The one or more processors 202 (e.g., processing circuitry) may include, in certain implementations, microprocessors configured to execute instructions stored in the memory 206 or other accessible locations. Alternatively, the one or more processors 202 may be implemented as application-specific integrated circuits (ASICs), field-programmable gate arrays (FPGAs), and/or other devices designed to perform functions discussed herein in a dedicated manner. As will be appreciated, multiple processors 202 or processing components may be used to perform functions discussed herein in a distributed or parallel manner.

The memory 206 may encompass any tangible, non-transitory medium for storing data or executable routines. Although shown for convenience as a single block in FIG. 3, the memory 206 may encompass various discrete media (e.g., multiple memories) in the same or different physical locations. The memory 206 may store code for one or more visual effects 216 (e.g., light effects, images, animations, sprites, etc.) and/or program code to be executed by the processors 202. The one or more processors 202 (e.g., processing circuitry) may access data in the memory 206 via one or more busses 204. In some embodiments, the various components may communicate with one another wirelessly.

The input structures 208 may allow a user to input data and/or commands to the computing device 200 and may include mice, touchpads, touchscreens, keyboards, controllers, and so forth. In some embodiments, the input structures 208 may also be configured to receive data from other devices, such as the sensors 102. The power source 210 can be any suitable source for providing power to the various components of the computing device 200, including line and battery power. In the depicted example, the device 200 includes a network interface 212. The network interface 212 may allow communication with other devices on a network using one or more communication protocols. In the depicted example, the computing device 200 includes a user interface 214, such as a display that may display images or data provided by the one or more processors 202. The user interface 214 may include, for example, a monitor, a display, and so forth. As will be appreciated, in a real-world context, a processor-based system, such as the computing device 200 of FIG. 3, may be employed to implement some or all of the present approach, such as performing the functions of the cloud projection system 32 and the servers 36, shown in FIGS. 1 and 2, as well as other memory-containing devices.

FIG. 4 is a flow chart of a process 300 for projecting visual effects onto a cloud. At 302, the process 300 emits a cloud or cloud material. The cloud may be emitted based on a schedule (e.g., at some specific moment in time, after some period of time has elapsed, during a sequence of events, etc.), in response to some trigger (e.g., a button being pressed, receiving a command from a device, an object or person being present, a connection being established, etc.), in response to a condition (e.g., that the fogger has been moved in a particular way or motion, in response to certain sounds being detected, in response to light conditions being detected, etc.), or for some other reason. The cloud emitted by the process 300 at block 302 may be water vapor or vapor of some other fluid, smoke, aerosol, particulate matter, etc. In some embodiments, the fluid may include one or more additives (e.g., metals, ceramics, or other substances) that may make the cloud easier to detect and/or project visual effects onto. In some embodiments, the fluid may be heated or cooled in order to make the cloud easier to detect, make the visual effects projected onto the cloud more visible, and/or to make the cloud have different characteristics (e.g., dissipate slower or faster, stay in place, etc.).

At 304, the process 300 detects a location of the cloud emitted at block 302. As previously described, in some embodiments, one or more LiDAR sensors may be used to locate the cloud in three-dimensional space. In some embodiments, other sensors may be used. For example, in some embodiments, imaging sensors, infrared sensors, RADAR, light detection sensors, proximity sensors, chemical sensors, or any combination thereof may be used to detect the location of the cloud. In some embodiments, sensors from different locations may collect data about the location of the cloud, and/or boundaries of the cloud, and pass the data to a central device, such as a server, for processing.

At 306, the process 300 uses the data collected from the one or more sensors to map the cloud into three-dimensional space. For example, the process 300 may generate a series of coordinates identifying where the cloud is and/or identifying a boundary of the cloud. In some embodiments, the coordinates may identify, for example, a center of mass and a radius from which the cloud extends from the center of mass. In some embodiments, the coordinates may represent a cluster of points that correspond to the cloud. In some embodiments, the coordinates may represent a boundary of the cloud at which point some measured value (e.g., density, reflectivity, concentration, visibility, etc.) falls below some threshold value. Accordingly, points inside the boundary may be assumed to be inside the cloud. In such embodiments, the coordinates may describe one or more contours of the cloud based on experimental data (e.g., from the sensors), model fit to collected data, and so forth, or some combination thereof.

Though the detection of the cloud at block 304 may be via a visual sensor or some other type of sensor, the series of coordinates generated in block 306 may roughly correspond to a three-dimensional space in which the measured reflectivity and/or visibility of the cloud is above some threshold value such that the visual characteristics of the cloud enable projected visual effects to the visible to a spectator. In some embodiments, concentration and or density of the cloud may be assumed to be above some threshold value such that the visual characteristics (e.g., reflectivity, visibility, etc.) of the cloud may act as a proxy for concentration. However, in some embodiments, the relationship may work in the opposite direction. For example, a chemical sensor may be used to detect the location of the cloud and the chemical concentration and/or density of the cloud at different data points, which may act as a proxy for suitability (e.g., visibility, reflectivity, etc.) for projection of visual effects.

At 308, the process 300 projects visual effects onto the cloud. As previously described, data defining visual effects (e.g., light, images, animations, sprites, etc.) may be stored in memory as scripts or portions of code that define characteristics of the visual effects, such as shape, size, how the visual effect articulates as it moves, the speed of a visual effect, and so forth. Further one or more parameters of the visual effects may be adjustable via an interface. Accordingly, the process 300 retrieves the scripts/code and modifies the visual effect to be projected onto the coordinates onto which the cloud was mapped at block 306. This may include, for example, adjusting a size of the visual effects, adjusting the intended location of projection, and/or adjusting one or more other characteristics of the visual effects. Data may then be sent to one or more projectors 104. In some embodiments, the process 300 may project visual effects onto the cloud from multiple projectors 104 in order to create a more complex visual effect, such as multiple types of effects, a three-dimensional and/or holographic visual effect, etc. In such embodiments, the process 300 may prepare different datasets/instructions for different projectors 104. The visual effects may include constant or flashing light of one or more colors, sparkles representing magic and/or a spell, an animal, such as a bug, a bird, a worm, etc., bubbles, miniaturized human and non-human characters, ghosts, fictional characters, and so forth.

At block 310, the process 300 may utilize the one or more sensors to detect a change in the location, size, and/or contour of the cloud (e.g., via additional data). This may include, for example, a shift in location of the cloud, a change in size (e.g., due to dissipation) of the cloud, a change in the contour of the cloud, a new cloud, and so forth. Accordingly, the change in the location may be represented by a change in the coordinates of the center of mass of the cloud, a change in the radius of the cloud, a change in the location of the boundary of the cloud, coordinates corresponding to a new cloud, and so forth. In some embodiments, the one or more sensors may be constantly collecting data about the location of the cloud. In other embodiments, the sensors may collect periodic snapshots of data about the location of the cloud (e.g., based on a schedule, receiving a request, detecting a condition being met, etc.). As previously described, if multiple sensors are being used, sensor data may be passed and aggregated by a central device, such as a server.

At 312, the map of the cloud may be updated based on the new data. For example, a new set of coordinates may be generated identifying where the cloud is and/or identifying a new boundary of the cloud. At 314, visual effects being projected onto the cloud may be updated (e.g., an additional visual effect generated) based on the new data and additional instructions generated to project the additional visual effect onto the cloud. For example, if the location of the cloud has shifted, the visual effects being projected may be shifted to the new location. Further, if the cloud has dissipated, or the cloud has grown/shrunk, the scale of the visual effects may be increased or decreased to match a scale of the cloud. Further, if the cloud is determined to be dissipating, the visual effect may slow down, speed up, or otherwise adjusted to coordinate with the dissipation of the cloud. Additionally, if additional clouds have been detected, the visual effects being projected may be updated to include visual effects for the new cloud.

The present disclosure is directed to techniques for projecting visual effects onto a cloud (e.g., of vapor, smoke, aerosol, particulate matter, etc.) in a curated environment (e.g., amusement parks, museums, historical sites, zoos, parks, art galleries, fairs, trade shows, conferences, conventions, expos, festivals, and so forth) using a cloud projection system. The cloud projection system includes a fogger, one or more sensors, a processor-based computing device, and a projector 104. The fogger emits a cloud or cloud material, such as vapor, smoke, aerosol, dust, particulate matter, and so forth to form a cloud in the curated environment. The cloud may be emitted on a schedule (e.g., at a particular time, of after a period of time has elapsed), in response to an input (e.g., a button being pressed), in response to some condition being detected (e.g., light conditions, sound conditions, a person, animal, or object being present, a command being received, etc.), and so forth. One or more sensors (e.g., LiDAR sensors) detect the location of the cloud and output data representative of the location of the cloud to the computing device. The location could be determined by a center of mass and a radius, a cluster of coordinates that fall within the cloud, a location of a boundary at which some measured value (e.g., visibility, reflectivity, density, concentration, etc.) crosses some threshold value, or some combination thereof. The computing device receives the data from the one or more sensors and maps the location of the cloud into three-dimensional space. The computing device retrieves data defining one or more visual effects and generates one or more visual effects to be projected onto the cloud. The computing device generates instructions to project the visual effects onto the cloud and outputs the instructions to one or more projectors 104, which project the visual effects onto the cloud in accordance with the instructions. The visual effects may include, for example, constant or flashing light of one or more colors, sparkles representing magic and/or a spell, an animal, such as a bug, a bird, a worm, etc., bubbles, miniaturized human and non-human characters, ghosts, fictional characters, and so forth. further, visual effects projected from multiple projectors 104 may create a three-dimensional holographic-like effect, creating the visual effect for a guest in the curated environment that the effect being projected onto the cloud is actually present in the cloud.

While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A cloud projection system, comprising:
a fogger configured to emit a cloud;
a sensor configured to detect a location of the cloud and output data indicative of the location of the cloud;
a server comprising:
processing circuitry; and
memory, accessible by the processing circuitry, the memory storing instructions that, when executed by the processing circuitry, are configured to cause the processing circuitry to perform operations comprising:
receiving, from the sensor, the data indicative of the location of the cloud;
mapping the data indicative of the location of the cloud into three-dimensional space;
generating a visual effect to be projected onto the cloud based on the mapping; and
outputting instructions to project the generated visual effect onto the cloud; and
a projector configured to:
receive the instructions from the server; and
project the generated visual effect onto the cloud based on the instructions.

2. The cloud projection system of claim 1, wherein the visual effect comprises light, an image, an animation, or any combination thereof.

3. The cloud projection system of claim 1, wherein the sensor comprises a light detection and ranging (LiDAR) sensor.

4. The cloud projection system of claim 1, comprising an additional sensor configured to detect the location of the cloud and output additional data indicative of the location of the cloud, relative to the additional sensor.

5. The cloud projection system of claim 1, comprising an additional projector, wherein the additional projector is configured to project an additional generated visual effect onto the cloud.

6. The cloud projection system of claim 5, wherein the visual effect and the additional visual effect combine to form a three-dimensional visual effect.

7. The cloud projection system of claim 1, wherein mapping the data indicative of the location of the cloud of vapor into the three-dimensional space comprises generating a set of coordinates for the cloud in the three-dimensional space.

8. The cloud projection system of claim 7, wherein the set of coordinates represent:
a center of the cloud and a radius from the center of the cloud to an outer edge of the cloud;
a cluster of points that fall within the cloud;
a boundary of the cloud at which point a value measured by the sensor crosses a threshold value; or
any combination thereof.

9. The cloud projection system of claim 1, wherein the fogger comprises a button, wherein the fogger is configured to emit the cloud of vapor in response to the button being pressed.

10. The cloud projection system of claim 1, wherein the fogger comprises a sensor, wherein the fogger is configured to emit the cloud in response to a condition being sensed by the sensor.

11. The cloud projection system of claim 1, wherein:
the fogger comprises a reservoir configured to hold a fluid; and
a nozzle configured to convert the fluid into the cloud.

12. The cloud projection system of claim 11, wherein the fogger comprises an additional reservoir configured to hold an additional fluid configured to be added to the fluid before or while the fluid is converted to the cloud.

13. The cloud projection system of claim 11, wherein the fogger comprises a heating element configured to heat the fluid, a cooling element configured to cool the fluid, or both.

14. The cloud projection system of claim 1, wherein the operations comprise:
receiving, from the sensor, additional data indicative of a new location of the cloud;
mapping the additional data indicative of the new location of the cloud into the three-dimensional space;
generating an additional visual effect to be projected onto the cloud based on the mapping; and
outputting additional instructions to project the generated additional visual effect onto the cloud.

15. A method of cloud projection, the method comprising:
emitting a cloud;
detecting a location of the cloud;
mapping the location of the cloud into a three-dimensional space; and
projecting a visual effect onto the cloud.

16. The method of claim 15, wherein mapping the location of the cloud of vapor into the three-dimensional space comprises executing a projection routine stored in memory.

17. The method of claim 15, wherein the visual effect comprises light, an image, an animation, or any combination thereof.

18. A non-transitory computer readable medium storing instructions that, when executed by processing circuitry, cause the processing circuitry to perform operations comprising:
receiving, from a sensor, data indicative of a location of a cloud;
mapping the data indicative of the location of the cloud into three-dimensional space;
generating a visual effect to be projected onto the cloud based on the mapping; and
outputting, to a projector, instructions to project the generated visual effect onto the cloud.

19. The non-transitory computer readable medium of claim 18, wherein mapping the data indicative of the location of the cloud of vapor into the three-dimensional space comprises generating a set of coordinates for the cloud in the three-dimensional space, wherein the set of coordinates represent:
a center of the cloud and a radius from the center of the cloud to an outer edge of the cloud;
a cluster of points that fall within the cloud;
a boundary of the cloud at which point a value measured by the sensor crosses a threshold value; or
any combination thereof.

20. The non-transitory computer readable medium of claim 18, wherein the visual effect comprises light, an image, an animation, or any combination thereof, wherein the visual effect comprises a depiction of an animal, magic, a fictional character, or any combination thereof.
